(19) United States
(12) Patent Application Publication
(10) Pub. No.: US 2013/0246553 A1
(43) Pub. Date: Sep. 19, 2013

(54) DATA MIGRATION

(71) Applicant: Hyoung-Gon Lee, Seoul (KR)

(72) Inventor: Hyoung-Gon Lee, Seoul (KR)

(73) Assignee: EMPIRE TECHNOLOGY DEVELOPMENT LLC, Wilimington, DE (US)

(21) Appl. No.: 13/642,739

(22) PCT Filed: Mar. 16, 2012
(86) PCT No.: PCT/US12/29335

§ 371 Date: Oct. 22, 2012

(51) Int. Cl. G06F 15/167

(52) U.S. Cl. CPC G06F 15/167
USPC 709/213

(57) ABSTRACT

Technologies are generally described for processing data. In some examples, a method performed under control of a server may include receiving, from an end device, an instruction to migrate or move data stored in an original storage to a target storage, moving the data from the original storage to the target storage in response to the receipt of the instruction and updating meta-data stored in the server based on the movement of the data.

### BACKGROUND

Cloud computing refers to a supplement, consumption, and delivery model for Internet-based IT services. Cloud computing provides a user with computing resources over the Internet anytime, anywhere. Examples of cloud computing resources include a central processing unit (CPU), capacity, memory, storage, development platforms, application programs, and the like. Recently, cloud computing service providers are paying more and more attention how to more efficiently provide cloud computing service to end devices.

### SUMMARY

In an example, a method performed under control of a server may include receiving, from an end device, an instruction to move data stored in an original storage to a target storage, moving the data from the original storage to the target storage in response to the receipt of the instruction, and updating meta-data stored in the server based on the movement of the data.

In an example, a method performed under control of a server may include receiving, from an end device, an instruction to move data stored in an original storage to a target storage, retrieving the data from the original storage, and storing the retrieved data in the target storage.

In an example, a server may include a receiving unit configured to receive, from an end device, an instruction to move data stored in an original storage to a target storage, a meta-data storage unit configured to store meta-data that includes at least one of a present storage location of the data and contents of the data, a data processing unit configured to move the data from the original storage to the target storage in response to the receipt of the instruction and a meta-data updating unit configured to update the meta-data based on the movement of the data.

In an example, a computer-readable storage medium may store thereon computer-executable instructions that, in response to execution, cause a server to perform operations including receiving, from an end device, an instruction to move data stored in an original storage to a target storage, moving the data from the original storage to the target storage in response to the receipt of the instruction, and updating meta-data stored in the server.

In an example, a computer-readable storage medium may store thereon a program for moving data stored in an original storage to a target storage, which includes a receiving module configured to receive, from an end device, an instruction to move the data from the original storage to the target storage, a data processing module configured to retrieve the data from the original storage and to store the retrieved data in the target storage, a meta-data storage unit configured to store meta-data that includes at least one of a present storage location of the data and contents of the data, and a meta-data updating unit configured to update the meta-data based on the movement of the data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1A schematically shows an illustrative example of an environment in which an end device is connected to an original storage, arranged in accordance with at least some embodiments described herein;

FIG. 1B schematically shows an illustrative example of an environment in which a server moves data from an original storage to a target storage, arranged in accordance with at least some embodiments described herein;

FIG. 1C schematically shows an illustrative example of an environment in which an end device is connected to a target storage after moving data from an original storage, arranged in accordance with at least some embodiments described herein;

FIG. 2 schematically shows an illustrative example of an environment in which a server reads out data from one of an original storage and a target storage, arranged in accordance with at least some embodiments described herein;

FIG. 3 schematically shows an illustrative example of an environment in which a server stores data in a target storage, arranged in accordance with at least some embodiments described herein;

FIG. 4 shows a schematic block diagram illustrating an example architecture for a server, arranged in accordance with at least some embodiments described herein;

FIG. 5 shows an example flow diagram of a process of a server for moving data from an original storage to a target storage, arranged in accordance with at least some embodiments described herein;

FIG. 6 shows an example flow diagram of a process of a server for reading out data from one of an original storage and a target storage, arranged in accordance with at least some embodiments described herein;

FIG. 7 shows an example flow diagram of a process of a server for storing data in a target storage, arranged in accordance with at least some embodiments described herein;

FIG. 8 illustrates computer program products that may be utilized to process data, arranged in accordance with at least some embodiments described herein; and

FIG. 9 is a block diagram illustrating an example computing device that may be utilized to process data, arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and changes may be made, without departing from the spirit or scope of the subject matter presented herein. It will be readily understood that the aspects of the present disclosure, as generally described herein, and illustrated in the drawings, can be arranged, substituted, combined, separated, and designed in a wide variety of different configurations, all of which are explicitly contemplated herein.

This disclosure is generally drawn, inter alia, to methods, apparatuses, systems, devices, and computer program products related to data migration.

Technologies are generally described for moving data seamlessly from one storage to another storage. In some embodiments, a user of an end device may store data in an original storage, which may be a cloud storage server or a storage unit of a cloud system. The user of the end device may want to move all of the data (which may be comprised of one or more data files) stored in the original storage to another storage (i.e., a “target storage”), which may also be a cloud storage server or a storage unit of a cloud system. In such cases, the user of the end device may perform migration of the data from the original storage to the target storage via a server which is operatively connected to the end device, the original storage and the target storage.

In some embodiments, the server may receive, from the end device, an instruction to move the data stored in the original storage to the target storage and, in response to the receipt of the instruction, move the data from the original storage to the target storage. The server may be a meta-data sever and have meta-data. By way of example, but not as a limitation, the meta-data may include, but not be limited thereto, a present storage location of the data and contents of the data, and the present storage location of the data may include a present storage location of each of the one or more data files of the data. After moving at least one of the one or more data files of the data from the original storage to the target storage, the server may update the meta-data with regard to the present storage location of the data.

In some embodiments the user of the end device may want to read out at least a part of the data (i.e., at least one of the one or more data files of the data) before the migration of the data from the original storage to the target storage has been completed. In such cases, the server may identify the present location of the at least part of the data (i.e., one of the original storage and the target storage) by using the meta-data and based on that the identified present location, the server may provide the at least part of the data requested by the user of the end device.

In some embodiments, the user of the end device may want to modify at least part of the data (i.e., at least one of the one or more data files of the data) before the migration of the data from the original storage to the target storage has been completed. In such cases, the server may receive the modified at least part of the data from the end device and store it in the target device. Further, the server may update the meta-data with regard to the present storage location of the modified at least part of the data.

In some embodiments, after the migration of the data from the original storage to the target storage has been completed, the server may be directly connected to the target storage for readout and/or storing of the data.

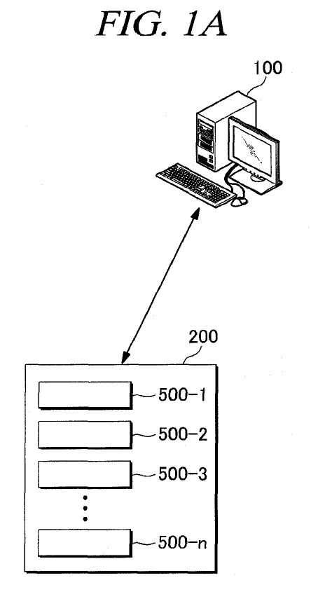

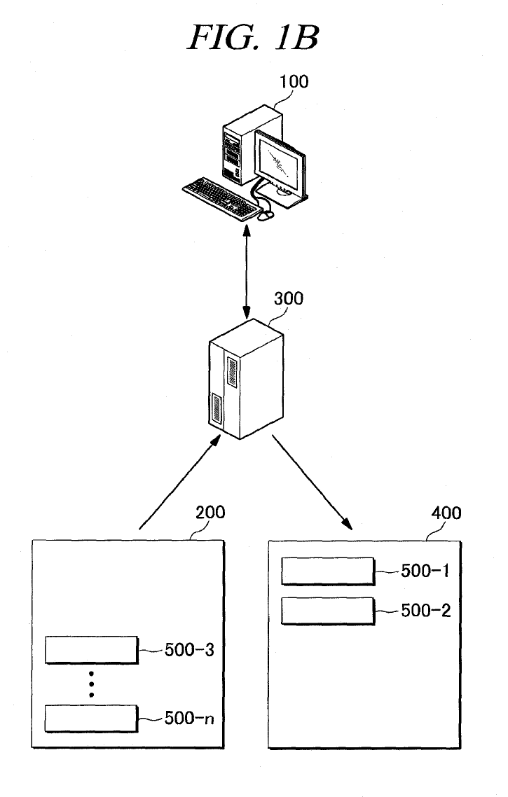

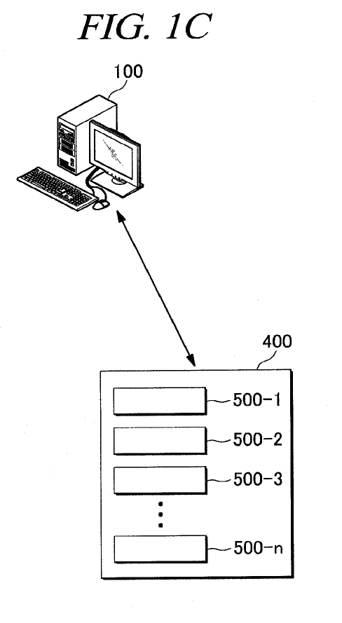

FIG. 1A schematically shows an illustrative example of an environment in which an end device is connected to an original storage in accordance with at least some embodiments described herein. As depicted in FIG. 1A, an end device 100 may be connected to an original storage 200. In some embodiments, original storage 200 may include a cloud storage server or a storage unit of a cloud system. By way of example, but not as a limitation, the cloud storage server may be a model of networked online storage where data is stored on virtualized pools of storage, and the storage unit of the cloud system may be a database that typically runs on a cloud computing platform. End device 100 may be configured to store data which may be comprised of data files 500-1 to 500-n in original storage 200 and read out the stored data from original storage 200.

By way of example, end device 100 may include, but not be limited thereto, a desktop computer, a notebook computer, a laptop computer, a personal portable terminal and a server device. The aforementioned personal portable terminal may include all kinds of handheld wireless communication apparatuses such as PCS (Personal Communication System), GMS (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminals.

In some embodiments, a user of end device 100 may want to move the data stored in original storage 200 to another storage. Such a process for moving the data will be described with reference FIG. 1B below.

FIG. 1B schematically shows an illustrative example of an environment in which a server moves data from an original storage to a target storage in accordance with at least some embodiments described herein. As depicted in FIG. 1B, end device 100 may be operatively connected to a server 300, and server 300 may be operatively connected to original storage 200 and a target storage 400 to which the data stored in original storage 200 may be migrated or moved. In some embodiments, target storage 400 may include a cloud storage server or a storage unit of a cloud system.

In some embodiments, end device 100 may be operatively connected to server 300 via a first network, original storage 200 may be operatively connected to server 300 via a second network, and target storage 400 may be operatively connected to server 300 via a third network. By way of example, but not as a limitation, at least one of the first network, the second network, and the third network may include a wired network such as LAN (Local Area Network), WAN (Wide Area Network), VAN (Value Added Network), a wired internet network or the like, and all kinds of wireless network such as a mobile radio communication network, a satellite network, a bluetooth, Wibro (Wireless Broadband Internet), HSDPA (High Speed Downlink Packet Access), a wireless internet network or the like.

In some embodiments, server 300 may receive, from end device 100, an instruction to move the data stored in original storage 200 to target storage 400. In response to the receipt of the instruction, server 300 may move the data from original storage 200 to target storage 400. By way of example, but not as a limitation, server 300 may be configured to retrieve the data from original storage 200 and store the retrieved data in target storage 400 in response to the instruction to migrate or move the data stored in original storage 200 to target storage 400.

In some embodiments, server 300 may start, in response to the instruction to move the data stored in original storage 200 to target storage 400, moving of data files 500-1 to 500-n until all of data files 500-1 to 500-n are moved to target storage 400.

In some embodiments, server 300 may store meta-data. By way of example, but not as a limitation, the meta-data may include at least one of a present storage location of the data and contents of the data. The present storage location of the data is at least one of original storage 200 and target storage 400, and the present storage location of the data may include a present storage location of each of data files 500-1 to 500-n of the data. After moving at least one of data files 500-1 to 500-n of the data from original storage 200 to target storage 400, server 300 may update the meta-data with regard to the present storage location of the data. Accordingly, server 300 may store information indicating a present storage location of data having certain contents.

FIG. 1C schematically shows an illustrative example of an environment in which an end device is connected to a target storage after migrating or moving data from an original storage in accordance with at least some embodiments described herein. After completing the process for moving the data (which may be comprised of data files 500-1 to 500-n) as described with reference to FIG. 1B above, server 100 may be directly connected to target storage 400 as depicted in FIG. 1C. Accordingly, server 300 may store data in target storage 400 and read out the stored data from target storage 400.

As a non-limiting summary of the above explanation with reference to FIGS. 1A-C, the user of end device 100 may move the entirety of data (regardless of size) stored in original storage 200 to target storage 400 via server 300, and server 300 may maintain and update the meta-data including a present location of each of data files 500-1 to 500-n of the data (i.e., one of original storage 200 and target storage 400) and contents of the data. Accordingly, during the migration or movement of the data from original storage 200 to target storage 400, server 300 may identify the present location of each of data files 500-1 to 500-n of the data.

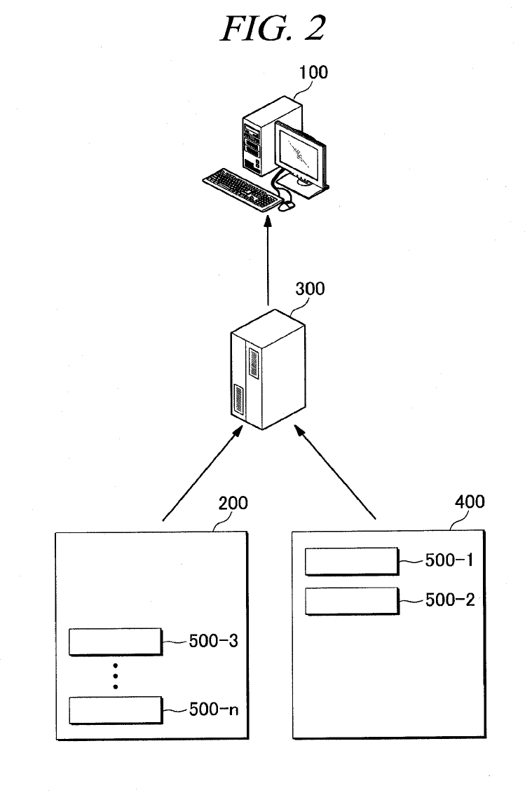

FIG. 2 schematically shows an illustrative example of an environment in which a server reads out data from one of an original storage and a target storage in accordance with at least some embodiments described herein. As depicted in FIG. 2, end device 100 may request server 300 to read out at least a part of the data (i.e., at least one of data files 500-1 to 500-n of the data) during the migration or movement of the data which is explained with reference to FIG. 1B above. As described above, since server 300 may maintain, in the meta-data, the present storage location of each of data files 500-1 to 500-n of the data, server 300 may identify whether the requested data is stored at original storage 200 or at target storage 400.

In some embodiments, in receipt of a readout request of at least one of the data files 500-1 to 500-n of the data from end device 100, server 300 may identify the present location of the requested data file by referring to the meta-data and retrieve the requested data file based on the present location of the requested data file. In some embodiments, the meta-data may include a lookup table showing the present storage location of data files 500-1 to 500-n and contents of data files 500-1 to 500-n. Server 300 may identify the present location of the requested data file by referring to the lookup table. In some embodiments, the meta-data may be attached to respective data files 500-1 to 500-n and server 300 may identify the present location of the requested data file based on the meta-data attached to respective data files 500-1 to 500-n. The present location of the requested data file may be one of original storage 200 and target storage 400. By way of example, but not as a limitation, if the requested data file is data file 500-3 which has not yet been moved to target storage 400, the present storage location of the requested data file (i.e., data file 500-3) may be original storage 200; and if the requested data file is data file 500-1 which has already been moved to target storage 400, the present storage location of the requested data file (i.e., data file 500-1) may be target storage 400. Server 300 may then provide end device 100 with the requested data file retrieved from the present storage location.

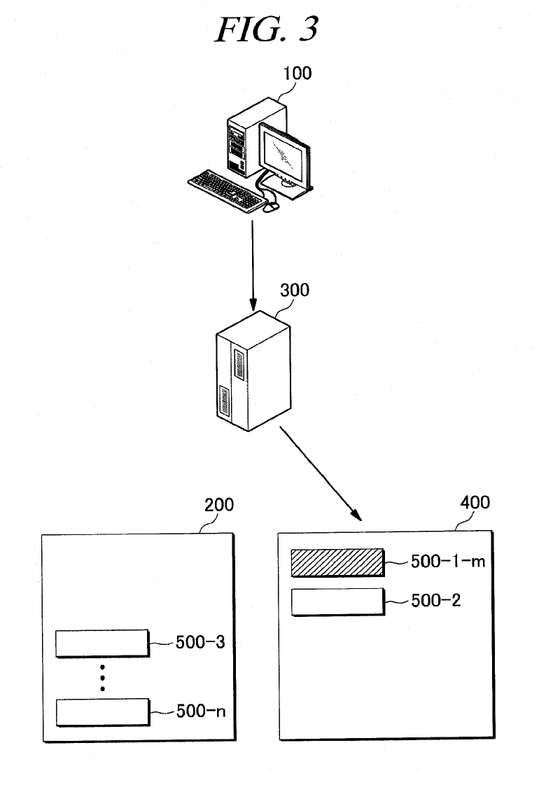

FIG. 3 schematically shows an illustrative example of an environment in which a server stores data in a target storage in accordance with at least some embodiments described herein. As depicted in FIG. 3, end device 100 may request server 300 to store other data during the migration or movement of the data, which is explained with reference to FIG. 1B above. Upon receiving the other data from end device 100, server 300 may store the other data at target storage 400.

In some embodiments, end device 100 may read out at least part of the data during the migration or movement of the data, as described with reference FIG. 2 above. The user of end device 100 may modify the at least part of the data, and then act to store the modified data. In such cases, server 300 may receive the modified data from end device 100 and store the modified data in target storage 400. For example, but not as a limitation, the user of end device 100 may want to read out and modify data file 500-1 into a modified data file 500-1-m, and then store modified data file 500-1-m. In such cases, server 300 may receive modified data file 500-1-m from end device 100 and store modified data file 500-1-m in target storage 400. In some embodiments, the user of end device 100 may act to store new data, and in such cases, server 300 may receive the new data from end device 100 and store the new data in target storage 400.

In some embodiments, when server 300 stores the other data (i.e., modified data or new data) in target storage 400, server 300 may update the meta-data to include at least one of a present storage location of the other data and contents of the other data.

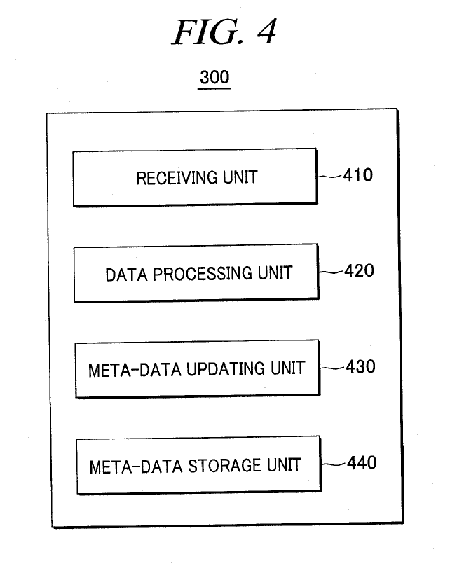

FIG. 4 shows a schematic block diagram illustrating an example architecture for a server in accordance with at least some embodiments described herein. As depicted in FIG. 4, server 300 may include a receiving unit 410, a data processing unit 420, a meta-data updating unit 430, and a meta-data storage unit 440. Although illustrated as discrete components, various components may be divided into additional components, combined into fewer components, or eliminated altogether while being contemplated within the scope of the disclosed subject matter. Server 300 may operatively connected to end device 100, original storage 200, and target storage 400, collectively or in different combinations, as described with reference to FIG. 1B above.

Receiving unit 410 may be configured to receive, from end device 100, an instruction to migrate or move data stored in original storage 200 to target storage 400. Further, receiving unit 410 may receive a readout request of data from end device 100. Furthermore, receiving unit 410 may receive other data from end device 100 to store the other data. The other data may include at least one of new data and modified data that has been modified from the data stored in original storage 200 or target storage 400.

Data processing unit 420 may be configured to move the data from original storage 200 to target storage 400. Specifically, when receiving unit 410 receives, from end device 100, an instruction to move data stored in original storage 200 to target storage 400, data processing unit 420 may move the data from original storage 200 to target storage 400 in response to the receipt of the instruction.

Further, when receiving unit 410 receives the readout request of data from end device 100, data processing unit 420 may retrieve the corresponding data based on a present storage location of the data and provide the retrieved data to end device 100. In some embodiments, server 300 may store meta-data, which may include, but not be limited thereto, a present storage location of the data and contents of the data. The present storage location of the data is at one of original storage 200 and target storage 400. Accordingly, by referring to the meta-data, data processing unit 420 may retrieve the data requested by end device 100 from one of original storage 200 and target storage 400.

Furthermore, when receiving unit 410 receives other data from end device 100, data processing unit 420 may store the other data in target storage 400. The other data may include at least one of data which is modified from the data and new data.

Meta-data updating unit 430 may update the meta-data based on the movement of the data. In some embodiments, when data processing unit 420 moves the data from original storage 200 to target storage 400, meta-data updating unit 430 may update the meta-data.

Further, meta-data updating unit 430 may update the meta-data based on the storing of the other data. In some embodiments, when data processing unit 420 stores the other data in target storage 400, meta-data updating unit 430 may update the meta-data so that the meta-date may include at least one of a present storage location of the other data and contents of the other data.

Meta-data storage unit 440 may store the meta-data which includes at least one of the present storage location of the data and the other data and the contents of the data and the other data.

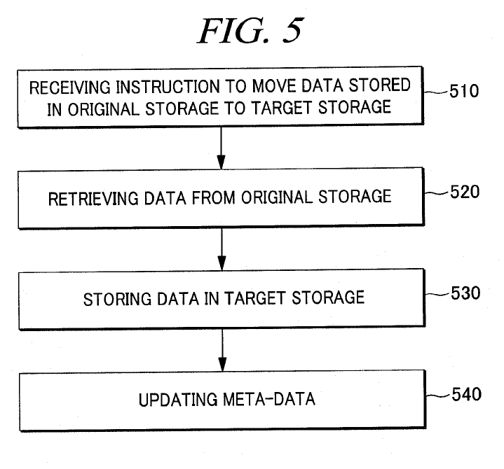

FIG. 5 shows an example flow diagram of a process of a server for moving data from an original storage to a target storage in accordance with at least some embodiments described herein. The process in FIG. 5 may be implemented in or by server 300, which may include receiving unit 410, data processing unit 420, meta-data updating unit 430 and meta-data storage unit 440 discussed above. An example process may include one or more operations, actions, or functions as illustrated by one or more blocks 510, 520, 530 and/or 540. Although illustrated as discrete blocks, various blocks may be divided into additional blocks, combined into fewer blocks, or eliminated, depending on the desired implementation. Processing may begin at block 510.

At block 510, server 300 may receive, from end device 100, an instruction to migrate or move data stored in original storage 200 to target storage 400. Processing may continue from block 510 to block 520.

At block 520, server 300 may retrieve the data from original storage 200. Processing may continue from block 520 to block 530.

At block 530, server 300 may store the retrieved data in target storage 400. Processing may continue from block 530 to block 540.

At block 540, server 300 may update meta-data stored in server 300 based on the migration or movement of the data, which is performed at block 520 and block 530. By way of example, but not as a limitation, the meta-data may include at least one of a present storage location of the data and contents of the data. The present storage location of the data is at one of original storage 200 and target storage 400.

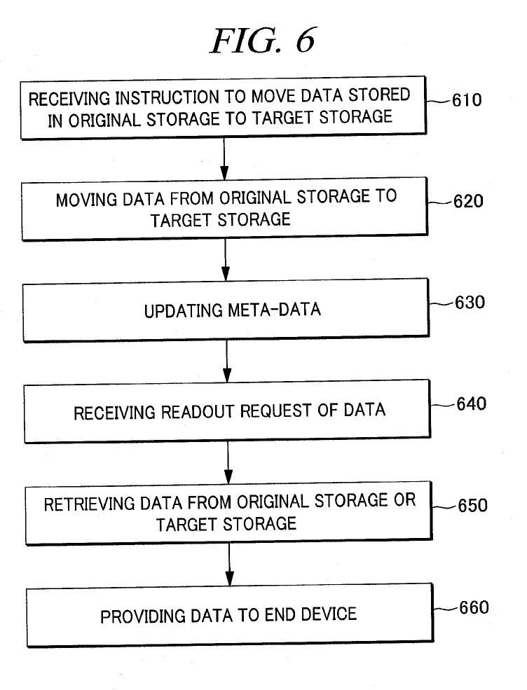

FIG. 6 shows an example flow diagram of a process of a server for reading out data from one of an original storage and a target storage in accordance with at least some embodiments described herein. The process in FIG. 6 may be implemented in or by server 300, which may include receiving unit 410, data processing unit 420, meta-data updating unit 430 and meta-data storage unit 440 discussed above. An example process may include one or more operations, actions, or functions as illustrated by one or more blocks 610, 620, 630, 640, 650 and/or 660. Although illustrated as discrete blocks, various blocks may be divided into additional blocks, combined into fewer blocks, or eliminated, depending on the desired implementation. Processing may begin at block 610.

At block 610, server 300 may receive, from end device 100, an instruction to migrate or move data stored in original storage 200 to target storage 400. Processing may continue from block 610 to block 620.

At block 620, server 300 may move the data from original storage 200 to target storage 400 in response to the receipt of the instruction. Specifically, server 300 may retrieve the data from original storage 200 and store the retrieved data in target storage 400. Processing may continue from block 620 to block 630.

At block 630, server 300 may update meta-data which includes at least one of a present storage location of the data and contents of the data based on the movement of the data performed at block 620. Processing may continue from block 630 to block 640.

At block 640, server 300 may receive a readout request of the data from end device 100. Processing may continue from block 640 to block 650.

At block 650, server 300 may retrieve the data based on the present storage location of the data. Specifically, by referring to the meta-data, server 300 may retrieve the data from one of original storage 200 and target storage 400. Processing may continue from block 650 to block 660.

At block 660, server 300 may provide the retrieved data to end device 100.

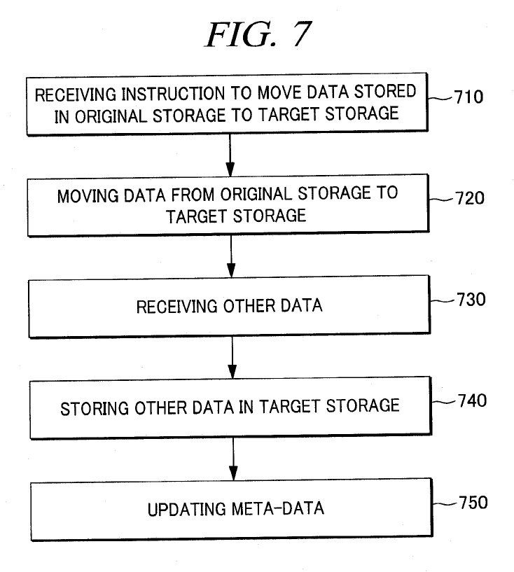

FIG. 7 shows an example flow diagram of a process of a server for storing data in or at a target storage in accordance with at least some embodiments described herein. The process in FIG. 7 may be implemented in or by server 300, which may include receiving unit 410, data processing unit 420, meta-data updating unit 430 and meta-data storage unit 440 discussed above. An example process may include one or more operations, actions, or functions as illustrated by one or more blocks 710, 720, 730, 740 and/or 750. Although illustrated as discrete blocks, various blocks may be divided into additional blocks, combined into fewer blocks, or eliminated, depending on the desired implementation. Processing may begin at block 710.

At block 710, server 300 may receive, from end device 100, an instruction to migrate or move data stored in original storage 200 to target storage 400. Processing may continue from block 710 to block 720.

At block 720, server 300 may move the data from original storage 200 to target storage 400 in response to the receipt of the instruction. Specifically, server 300 may retrieve the data from original storage 200 and store the retrieved data in target storage 400. Though not shown in FIG. 7, after the moving of the data, server 300 may update meta-data which includes at least one of a present storage location of the data and contents of the data. Processing may continue from block 720 to block 730.

At block 730, server 300 may receive other data from end device 100. The other data may include at least one of data which is modified from the data stored in original storage 200 or target storage 400 and new data. Processing may continue from block 730 to block 740.

At block 740, server 300 may store the other data in target storage 400. Processing may continue from block 740 to block 750.

At block 750, server 300 may update the meta-data so that the meta-data may include at least one of a present storage location of the other data and contents of the other data based on the storing of the other data performed at block 740.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

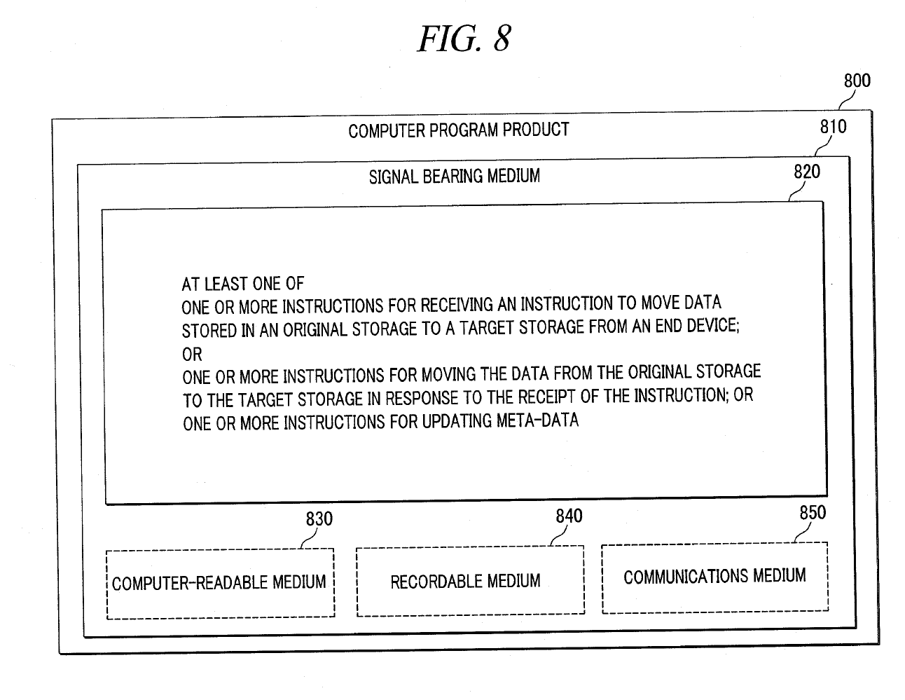

FIG. 8 illustrates computer program products that may be utilized to process data in accordance with at least some embodiments described herein. Program product 800 may include a signal bearing medium 810. Signal bearing medium 810 may include one or more instructions 820 that, when executed by, for example, a processor, may provide the functionality described above with respect to FIGS. 1-7. By way of example, instructions 820 may include: one or more instructions for receiving an instruction to move data stored in an original storage to a target storage from an end device; one or more instructions for moving the data from the original storage to the target storage in response to the receipt of the instruction; and one or more instructions for updating meta-data stored in the server. Thus, for example, referring to FIG. 4, server 300 may undertake one or more of the blocks shown in FIGS. 5 to 7 in response to instructions 820.

In some implementations, signal bearing medium 810 may encompass a computer-readable medium 830, including, but not limited to, a hard disk drive, a CD, a DVD, a digital tape, memory, etc. In some implementations, signal bearing medium 810 may encompass a recordable medium 840, including, but not limited to, memory, read/write (R/W) CDs, R/W DVDs, etc. In some implementations, signal bearing medium 810 may encompass a communications medium 850, including, but not limited to, a digital and/or an analog communication medium (e.g., a fiber optic cable, a waveguide, a wired communications link, a wireless communication link, etc.). Thus, for example, program product 800 may be conveyed to one or more modules of server 300 by an RF signal bearing medium 820, where the signal bearing medium 820 is conveyed by a wireless communications medium 850 (e.g., a wireless communications medium conforming with the IEEE 802.11 standard).

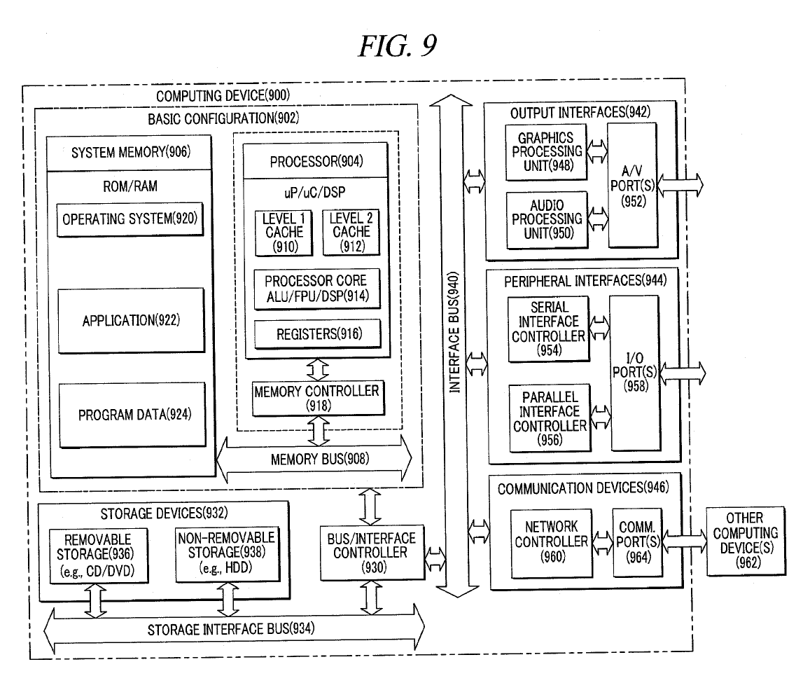

FIG. 9 is a block diagram illustrating an example computing device 900 that may be utilized to process data in accordance with at least some embodiments described herein. In a very basic configuration 902, computing device 900 typically includes one or more processors 904 and a system memory 906. A memory bus 908 may be used for communicating between processor 904 and system memory 906.

Depending on the desired configuration, processor 904 may be of any type including but not limited to a microprocessor (μP), a microcontroller (μC), a digital signal processor (DSP), or any combination thereof. Processor 904 may include one more levels of caching, such as a level one cache 910 and a level two cache 912, a processor core 914, and registers 916. An example processor core 914 may include an arithmetic logic unit (ALU), a floating point unit (FPU), a digital signal processing core (DSP Core), or any combination thereof An example memory controller 918 may also be used with processor 904, or in some implementations memory controller 918 may be an internal part of processor 904.

Depending on the desired configuration, system memory 906 may be of any type including but not limited to volatile memory (such as RAM), non-volatile memory (such as ROM, flash memory, etc.) or any combination thereof. System memory 906 may include an operating system 920, one or more applications 922, and program data 924.

Computing device 900 may have additional features or functionality, and additional interfaces to facilitate communications between basic configuration 902 and any required devices and interfaces. For example, a bus/interface controller 930 may be used to facilitate communications between basic configuration 902 and one or more data storage devices 932 via a storage interface bus 934. Data storage devices 932 may be removable storage devices 936, non-removable storage devices 938, or a combination thereof Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 906, removable storage devices 936 and non-removable storage devices 938 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 900. Any such computer storage media may be part of computing device 900.

Computing device 900 may also include an interface bus 940 for facilitating communication from various interface devices (e.g., output devices 942, peripheral interfaces 944, and communication devices 946) to basic configuration 902 via bus/interface controller 930. Example output devices 942 include a graphics processing unit 948 and an audio processing unit 950, which may be configured to communicate to various external devices such as a display or speakers via one or more AN ports 952. Example peripheral interfaces 944 include a serial interface controller 954 or a parallel interface controller 956, which may be configured to communicate with external devices such as input devices (e.g., keyboard, mouse, pen, voice input device, touch input device, etc.) or other peripheral devices (e.g., printer, scanner, etc.) via one or more I/O ports 958. An example communication device 946 includes a network controller 960, which may be arranged to facilitate communications with one or more other computing devices 962 over a network communication link via one or more communication ports 964.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 900 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 900 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method performed under control of a server, comprising:
receiving, from an end device that is operatively connected to the server via a first network, an instruction to move data stored in an original storage, that is operatively connected to the server via a second network, to a target storage, that is operatively connected to the server via a third network;
moving the data from the original storage to the target storage in response to the receipt of the instruction; and
updating meta-data stored in the server based on the movement of the data.

2. (canceled)

3. The method of claim 1, wherein at least one of the first network, the second network and the third network is an internet network.

4. The method of claim 1,
wherein the meta-data includes at least one of a present storage location of the data and contents of the data, and
wherein the present storage location of the data is at one of the original storage and the target storage.

5. The method of claim 4, further comprising:
receiving, from the end device, a readout request of the data;
retrieving the data based on the present storage location of the data; and
providing the retrieved data to the end device.

6. The method of claim 4, further comprising:
receiving other data from the end device;
storing the other data in the target storage; and
updating the meta-data based on the storing of the other data.

7. The method of claim 6, wherein the other data is modified from the data.

8. A method performed under control of a server, comprising:
receiving, from an end device, an instruction to move data stored in an original storage to a target storage;
retrieving the data from the original storage; and
storing the retrieved data in the target storage.

9. The method of claim 8, wherein the server has meta-data that includes at least one of a present storage location of the stored data and contents of the stored data.

10. The method of claim 9, further comprising:
updating the meta-data based on the storing of the data.

11. The method of claim 10, further comprising:
receiving, from the end device, a readout request of the stored data;
retrieving the stored data based on the present storage location of the stored data; and
providing the stored data to the end device.

12. The method of claim 10, further comprising:
receiving other data from the end device;
storing the other data in the target storage; and
updating the meta-data based on the storing of the other data,
wherein the other data is modified from the stored data.

13. A server, comprising:
a receiving unit configured to receive, from an end device that is operatively connected to the server via a first network, an instruction to move data stored in an original storage, that is operatively connected to the server via a second network, to a target storage, that is operatively connected to the server via a third network;
a meta-data storage unit configured to store meta-data that includes at least one of a present storage location of the data and contents of the data;
a data processing unit configured to move the data from the original storage to the target storage in response to the receipt of the instruction; and
a meta-data updating unit configured to update the meta-data based on the movement of the data.

14. (canceled)

15. The server of claim 14, wherein at least one of the first network, the second network and the third network is an internet network.

16. The server of claim 13,
wherein the receiving unit is further configured to receive, from the end device, a readout request of the data, and
wherein the data processing unit is further configured to retrieve the data based on the present storage location of the data and to provide the retrieved data to the end device.

17. The server of claim 13,
wherein the receiving unit is further configured to receive, from the end device, other data that is modified from the data,
wherein the data processing unit is further configured to store the other data in the target storage, and
wherein the meta-data updating unit is further configured to update the meta-data based on the storing of the other data.

18. A computer-readable storage medium having stored thereon computer-executable instructions that, in response to execution, cause a server to perform operations, comprising:
receiving, from an end device, an instruction to move data stored in an original storage to a target storage;
moving the data from the original storage to the target storage in response to the receipt of the instruction; and
updating meta-data stored in the server.

19. The computer-readable storage medium of claim 18,
wherein the meta-data includes at least one of a present storage location of the data and contents of the data, and
wherein the present storage location of the data is at one of the original storage and the target storage.

20. The computer-readable storage medium of claim 19, wherein the operations further comprise:
receiving, from the end device, a readout request of the data;
retrieving the data based on the present storage location of the data; and
providing the retrieved data to the end device.

21. The computer-readable storage medium of claim 19, wherein the operations further comprise:
receiving, from the end device, other data that is modified from the data;
storing the other data in the target storage; and
updating the meta-data based on the storing of the other data.

22. A computer-readable storage medium that stores a program for moving data stored in an original storage to a target storage, the program comprising:
a receiving module configured to receive, from an end device that is operatively connected to a host of the computer-readable storage medium via a first network, an instruction to move the data from the original storage, that is operatively connected to the host of the computer-readable storage medium via a second network, to the target storage, that is operatively connected to the host of the computer-readable storage medium via a third network;
a data processing module configured to retrieve the data from the original storage and to store the retrieved data in the target storage;
a meta-data storage unit configured to store meta-data that includes at least one of a present storage location of the data and contents of the data; and
a meta-data updating unit configured to update the meta-data based on the movement of the data.

23. The computer-readable storage medium of claim 22, wherein the meta-data includes at least one of a present storage location of the data and contents of the data, and
wherein the present storage location of the data is at one of the original storage and the target storage.
